(19) United States
(12) Patent Application Publication
(10) Pub. No.: US 2025/0368273 A1
(43) Pub. Date: Dec. 4, 2025

(54) COCKPIT MODULE

(71) Applicant: HYUNDAI MOBIS CO., LTD., Seoul (KR)

(72) Inventors: Ik Keun CHOI, Yongin-si (KR); Da Som PARK, Yongin-si (KR)

(73) Assignee: HYUNDAI MOBIS CO., LTD., Seoul (KR)

(21) Appl. No.: 18/828,672

(22) Filed: Sep. 9, 2024

(30) Foreign Application Priority Data
Jun. 4, 2024 (KR) 10-2024-0073021

(51) Int. Cl. B62D 25/14; B60H 1/00; B60N 3/00; B60R 21/045

(52) U.S. Cl. CPC B62D 25/142; B60H 1/00564; B60N 3/002; B60R 21/045

(57) ABSTRACT

A cockpit module according to an embodiment of the present invention may include a crash pad lower member connected to an air conditioning unit, a crash pad upper member coupled to the crash pad lower member, and a first air conditioning duct formed integrally with the crash pad lower member, wherein the crash pad lower member may a duct groove formed by being recessed downwards and creating the first air conditioning duct with a first duct cover being placed on the top of the duct groove, remaining the upper part of the first air conditioning duct as an empty space to accommodate a tray formed by being recessed downwards from the crash pad upper member.

### CROSS REFERENCE TO RELATED APPLICATION

The present application claims priority to Korean Patent Application No. 10-2024-0073021, filed Jun. 4, 2024, the entire contents of which is incorporated herein for all purposes by this reference.

### BACKGROUND OF THE INVENTION

### Field of the Invention

The present invention relates to a cockpit module, and more particularly, to a cockpit module formed integrally with an air conditioning duct to secure storage space.

### Description of the Related Art

A cockpit module is arranged in the front of the passenger compartment of a vehicle, and a tray can be formed on the crash pad that makes up the cockpit module for the convenience of passengers. In particular, it is becoming a trend for conventional business-to-business (B2B) vehicles and recently developed purpose-built vehicles (PBVs) to feature an open tray at the top.

Despite the convenient storage offered by the open tray for small personal items, sudden stops or rapid acceleration of the vehicle pose a problem of spilling out the stored items. To address this issue effectively, it is necessary to develop a cockpit module capable of ensuring sufficient tray size and depth while minimizing interference with steering devices, other electrical components, and air conditioning units arranged on the inner side of the module.

### SUMMARY OF THE INVENTION

An embodiment of the present invention provides a cockpit module equipped with a tray capable of stable loading of items by securing the interior space of the crash pad in such a way as to form the crash pad and air conditioning duct integrally.

The technical objects of this invention are not limited to the aforesaid, and other objects not described herein with can be clearly understood by those skilled in the art from the descriptions below.

A cockpit module according to an embodiment of the present invention may include a crash pad lower member connected to an air conditioning unit, a crash pad upper member coupled to the crash pad lower member, and a first air conditioning duct formed integrally with the crash pad lower member.

The crash pad lower member may include a recessed duct groove and a first duct cover positioned on a top of the duct groove, and the recessed duct groove and first duct cover may define the first air conditioning duct. The crash pad upper member may include a recessed tray and is coupled to the crash pad lower member such that the tray is positioned above the first duct cover and the first air conditioning duct.

A coupling portion may be formed at a predetermined interval along a perimeter of the duct groove, and a position of the first duct cover may be fixed by the coupling portion.

The first air conditioning duct may include an air outlet formed at one end thereof, and the first duct cover may be fixed by the air outlet at one end thereof.

A second duct cover may be coupled to the crash pad lower member and cover a lower portion of the crash pad lower member, and the second duct cover and crash pad lower member may define a second air conditioning duct.

The first air conditioning duct may a vent duct, and the second air conditioning duct may include a defrost duct and a side hose.

The tray may include a sidewall that is perpendicular to a bottom surface of the tray.

A cockpit module according to another embodiment of the present invention may include a crash pad lower member including a second area configured to be placed in front of a vehicle, a first area positioned behind the second area, and a connecting portion connecting the first area and second area. The cockpit module may include a first duct cover coupled to the crash pad lower member, and a second duct cover coupled to the crash pad lower member.

The first area and the second area may be arranged to have a step and include a connecting portion connecting the first area and the second area, wherein the second area may be positioned above the first area, the second duct cover may be positioned under the second area, and the second duct cover, second area, and connecting portion define a second air conditioning duct, and the first area may include a recessed duct groove, the first duct cover may be positioned above the duct groove in the first area, and the duct groove and first duct cover may define a first air conditioning duct.

The first area may accommodate a crash pad upper member on a top thereof, the crash pad upper member including a recessed tray having a depth corresponding to a step distance between the first area and the second area.

The tray may include a sidewall that is perpendicular to a bottom surface of the tray.

The first air conditioning duct may a vent duct, and the second air conditioning duct may include a defrost duct and a side hose.

### BRIEF DESCRIPTION OF THE DRAWINGS

FIG. 1 is a perspective view of a cockpit module according to an embodiment of the present invention;

FIG. 2 is a diagram illustrating a crash pad lower member and a first duct cover according to an embodiment of the present invention;

FIG. 3 is an exploded view of a crash pad lower member and a first duct cover according to an embodiment of the present invention;

FIG. 4 is an exploded view of a crash pad lower member and a second duct cover according to an embodiment of the present invention;

FIG. 5 is an exploded view of a cockpit module according to an embodiment of the present invention;

FIG. 6 is a side cross-sectional view of a crash pad lower member and a duct cover according to an embodiment of the present invention;

FIG. 7 is a center cross-sectional view of a crash pad lower member and a duct cover according to an embodiment of the present invention;

FIG. 8 is a cross-sectional view of the driver seat side of a cockpit module according to an embodiment of the present invention;

FIG. 9 is a center cross-sectional view of the cockpit module according to an embodiment of the present invention;

FIG. 10 is a cross-sectional view of the passenger seat side of the cockpit module according to an embodiment of the present invention; and

FIGS. 11A-11C are diagrams illustrating the sealing structure of a duct cover according to an embodiment of the present invention.

### DETAILED DESCRIPTION OF THE INVENTION

While the present invention admits various modifications, the following detailed descriptions and drawings focus on preferred embodiments for clarity. However, such embodiments are not intended to limit the invention and it should be understood that the embodiments encompass all modifications, equivalents, and alternatives within the spirit and scope of the invention. Detailed descriptions of well-known technologies may be omitted to avoid obscuring the subject matter of the present invention.

Terms such as “first,” “second,” etc. may be used to describe various components, but the components should not be limited by these terms. The terms are used only for distinguishing one component from another component.

The terminology used in this application is employed merely to describe specific embodiments and is not intended to limit the scope of the present invention. The singular forms are intended to include the plural forms as well unless the context clearly indicates otherwise. In this application, terms such as “comprising” or “having” indicate the presence of the features, numbers, steps, operations, components, or parts listed in the specification, without excluding the presence or possibility of one or more other features, numbers, steps, operations, components, or parts or their combinations.

Throughout the specification, the term “connected” not only means that two or more components are directly connected but also includes indirect connections via intermediary components, electrical connections, and instances where components are referred to by different names based on their position or function but are considered as a whole.

Additionally, when a component is described as being formed or placed “on or under” another component, “on (above)” or “under (below)” may include not only cases where two components directly contact each other but also cases where one or more other components are formed or positioned between the two components. Additionally, when expressed as “on (above) or under (below),” it may include not only the upward direction but also the downward direction relative to a single component.

Hereinafter, a description is made of the cockpit module according to an embodiment of the present invention with reference to accompanying drawing, where identical or corresponding components are assigned the same reference numerals and repetitive descriptions are omitted.

Recently, purpose-built vehicles (PBVs) are gaining traction in research and development. Unlike conventional vehicles, PBVs are specifically designed for a particular purpose, optimizing the vehicle for that function. One example is a cargo delivery vehicle.

Due to the unique interior structure of PBVs compared to conventional vehicles, additional features may be incorporated into the cockpit module within the vehicle to enhance passenger convenience. Due to its large volume in front of the vehicle, necessitated by housing air conditioning and steering components, the cockpit module is a focus of research for size reduction to create more usable passenger space.

Open trays, commonly used on conventional vehicles, can be installed on top of the cockpit module, but their low heights and slanted sidewalls often cause stored items to fall out.

The present invention aims to provide a cockpit module 1 that facilitates storing items by increasing the space available for forming a tray 22 inside the cockpit module 1, thus ensuring the convenience of storing items. In the following, the direction facing the front of the vehicle is referred to as the front, and the direction facing the rear of the vehicle is referred to as the rear.

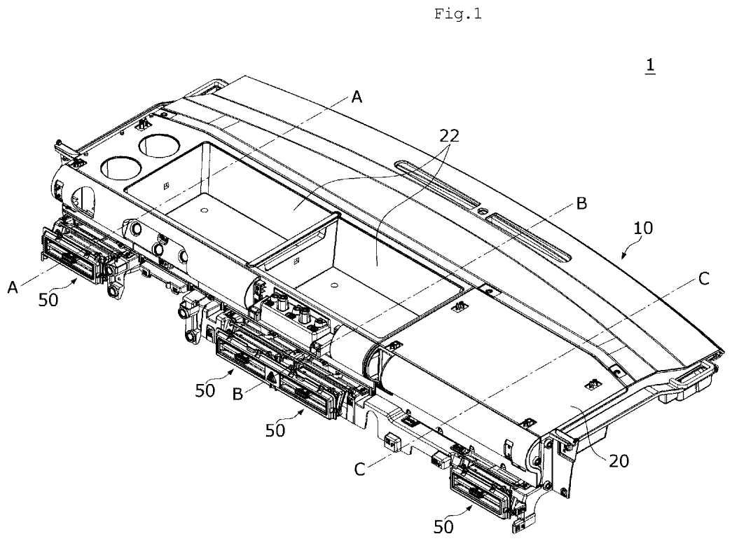

FIG. 1 is a perspective view of a cockpit module according to an embodiment of the present invention.

With reference to FIG. 1, the cockpit module 1 according to an embodiment of the present invention may include a crash pad lower member 10 connected to the air conditioning unit, a crash pad upper member 20 coupled to the crash pad lower member 10, and a first air conditioning duct 70 formed integrally with the crash pad lower member 10.

The crash pad 10 and 20 may be divided into upper and lower members, as described above, and the upper member 20 and lower member 10 of the crash pad may be assembled to form the exterior of the cockpit module 1. On the inner side of the crash pad 10 and 20, air conditioning units and ducts extending from the air conditioning units may be arranged, and in the present invention, the ducts may be formed integrally with the crash pad 10 and 20.

The crash pad upper member 20 forms the upper boundary of the cockpit module 1, and a tray 22 may be formed on the crash pad upper member 20. A tray 22 may be recessed relative to a top surface of the upper member 20 such that when the upper member 20 is coupled to the lower member 10 the tray 22 extends downwards toward the lower member 10 and/or first air conditioning duct 70. Although it is illustrated that two trays 22 are formed in this embodiment, there is no limitation on the number of trays 22, and it is also possible to form trays 22 of different sizes and quantities than those shown in FIG. 1. The interior of the cockpit module 1 may be equipped with a passenger-side airbag 60. As shown in FIG. 1, the passenger-side airbag 60 is provided on the right side. Trays 22 may be provided in the lateral empty space of the passenger-side airbag 60.

Although illustrated as open-type in this embodiment, the trays 22 is not limited in type. Therefore, it is also possible to have doors provided on the upper surface of the trays 22 to allow for opening and closing, pivoting from one side of the tray 22 with hinges. Alternatively, the doors may slide horizontally from the top of the trays 22 to the inside or outside of the crash pad 10 and 20 to open and close the trays 22.

The cockpit module 1 is provided in the front interior of the vehicle, and passengers may utilize the upper space of the cockpit module 1. The trays 22 are provided on the crash pad upper member 20, allowing passengers to store items inside the trays 22. In situations such as rapid acceleration or sudden stops of the vehicle, items stored inside the tray 22 may move within the tray 22 due to inertia. In such cases, when the sidewalls of the trays 22 are formed with a gentle slope or the depth of the tray 22 is shallow, there is a risk of stored items bouncing out of the tray 22.

In this embodiment, to prevent the aforementioned issue, the depth of the tray 22 is increased, and the sidewalls of the trays 22 are formed at a vertical or near-vertical angle, thereby preventing stored items inside the trays 22 from spilling outwards. Such configuration of the trays 22 may be implemented by integrating the air conditioning duct and crash pad 10 and 20, and the following details the configuration of the cockpit module 1 and structural characteristics.

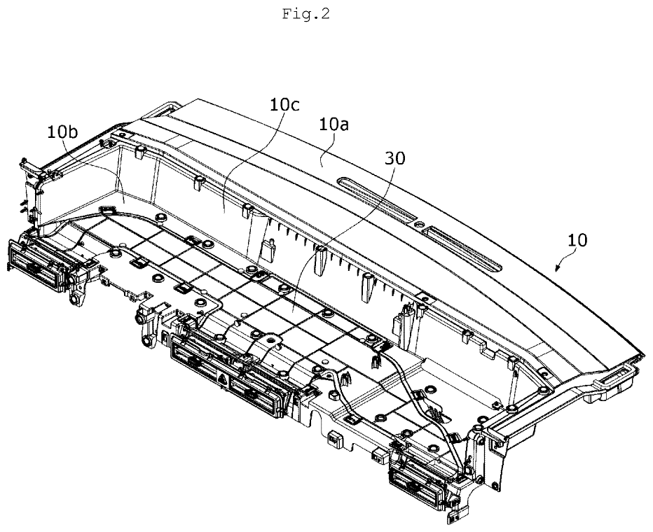

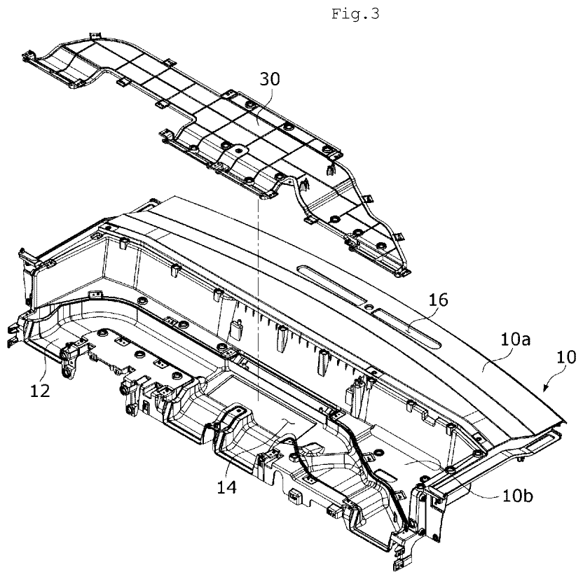

FIG. 2 is a diagram illustrating a crash pad lower member and a first duct cover according to an embodiment of the present invention, and FIG. 3 is an exploded view of a crash pad lower member and a first duct cover according to an embodiment of the present invention;

With reference to FIGS. 2 and 3, according to an embodiment of the present invention, the crash pad lower member 10 may have a duct groove 12 formed in a manner recessed downwards. One side of the duct groove 12 may have a hole 14 formed to communicate with the air conditioning unit, while the other side may have an outlet formed to expel air towards the passenger seat side. In this embodiment, it can be observed that the hole 14, communicating with the air conditioning unit, is formed at the center of the duct groove 12.

The upper part of the duct groove 12 may accommodate the first duct cover 30. The space surrounded by the duct groove 12 and the first duct cover 30 forms the first air conditioning duct 70, extending from the air conditioning unit to the outlet. That is, the first air conditioning duct 70 may be formed integrally with the crash pad lower member 10.

The first duct cover 30, which is seated on the crash pad lower member 10, may be formed to correspond to the shape of the duct groove 12. The first duct cover 30 may cover the open upper part of the duct groove 12 to form the first air conditioning duct 70. The first duct cover 30 may be positioned on the same plane as the portion of the crash pad lower member 10 that does not recessed downwards, i.e., the portion where the duct groove 12 is not formed. That is, when the first duct cover 30 is assembled onto the crash pad lower member 10, the first duct cover 30 and the crash pad lower member 10 positioned around the perimeter of the first duct cover 30 may be aligned on the same plane without any elevation differences, forming a flat surface and ensuring ample space.

The top of the first air conditioning duct 70 may be configured as an open space. As shown in FIGS. 2 and 3, the portion where the first air conditioning duct 70 is formed corresponds to the sunken side of the crash pad lower member 10, as the crash pad lower member 10 is sunken downwards at least some part thereof. The first air conditioning duct 70 is formed on the underside of the recessed portion, and the upper part of the first air conditioning duct 70 may remain as an empty space. For example, a space above the air conditioning duct 70 and/or first duct cover 30 may be recessed in relation to a top surface of the crash pad lower member 10 such that one or more components (e.g., the crash pad upper member 20) may be positioned at least partially therein.

By virtue of the open space at the top of the first air conditioning duct 70, the crash pad upper member 20 may be secured to the top of the first air conditioning duct 70, thereby forming the trays 22 deep on the crash pad upper member 20.

The first air conditioning duct 70 may correspond to a vent duct that discharges air towards the direction where passengers are located inside the vehicle from the cockpit module 1, as shown in FIGS. 1 to 3. That is, the outlet of the first air conditioning duct 70 may be opened on the passenger seat side from the cockpit module 1. In this embodiment, there are a total of four outlets, with two positioned in the center and two on the sides. The first air conditioning duct 70 is not limited in shape, and it is possible to form a first air conditioning duct 70 with a shape different from this embodiment by changing the shape of the duct groove 12 and the corresponding first duct cover 30.

The crash pad lower member 10 may be divided into two areas formed with a step. Therefore, from this perspective, the cockpit module 1 according to another embodiment of the present invention may be considered to include a crash pad lower member 10 divided into a second area 10a placed in the front of the vehicle and a first area 10b placed behind the second area 10a.

The first area 10b and the second area 10a of the crash pad lower member 10 are connected via a connecting portion 10c, and the second area 10a may be positioned above the first area 10b with a predetermined distance step. The first area 10b corresponds to the sunken part of the crash pad lower member 10, where the duct groove 12 may be formed. Thus, the first duct cover 30 may be assembled on the upper part of the first area 10b, and the first duct cover 30 and the first area 10b may be positioned on the same plane. The space where the crash pad upper member 20 is formed on the upper part of the first area 10b may be formed due to the step between the first area 10b and the second area 10a.

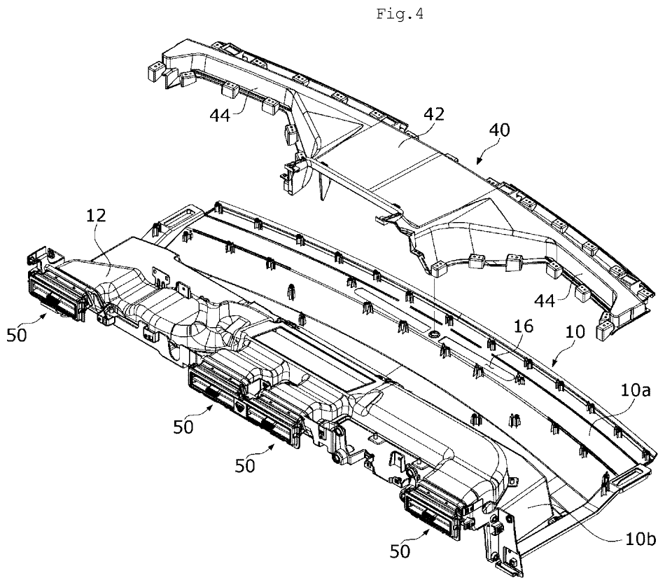

FIG. 4 is an exploded view of a crash pad lower member and a second duct cover according to an embodiment of the present invention.

With reference to FIG. 4, in an embodiment of the present invention, a second duct cover 40 may be arranged on the crash pad lower member 10 to form a second air conditioning duct 80. In the front of the cockpit module 1, a windshield is positioned, which may develop frost due to temperature differences between the inside and outside of the vehicle and humidity inside the vehicle. To prevent this, a defrost duct and outlet that discharges air towards the windshield may be provided at the front of the cockpit module 1. By adjusting the temperature of the windshield with air expelled from the defrost outlet, the formation of frost may be prevented.

As shown in FIG. 4, the second duct cover 40 is formed in a shape similar to the letter T. The second air conditioning duct 80 is also shaped accordingly to integrate a centrally-discharged defrost duct 42 and side hoses 44 expelling air towards the sides of the vehicle.

Therefore, a separate air conditioning duct may be provided in the front of the cockpit module 1. As shown in FIG. 4, the front lower surface of the crash pad lower member 10 may have the second duct cover 40 attached, and the portion surrounded by the crash pad lower member 10 and the second duct cover 40 may form the second air conditioning duct 80. The portion where the second air conditioning duct 80 is formed may be positioned in front of the empty space formed on the upper part of the first air conditioning duct 70. That is, the crash pad lower member 10 may be divided into two areas formed with a step.

Specifically, the second air conditioning duct 80 may be formed under the second area 10a. As the second area 10a is arranged with a step compared to the first area 10b, the lower part of the second area 10a may remain as empty space. In this portion, the second air conditioning duct 80 may be formed to communicate with the air conditioning unit and create a flow path for air. The second duct cover 40 may be assembled at the bottom of the second area 10a, and the area surrounded by the second duct cover 40, the second area 10a, and the connecting portion 10c may form the second air conditioning duct 80.

As the upper surface of the first air conditioning duct 70 can be formed as empty space, the adjacent portion in front of this space may also be provided as empty space, accommodating the second air conditioning duct 80. The second duct cover 40 may be assembled on the crash pad lower member 10 in the opposite direction to the first duct cover 30. The second air conditioning duct 80 may be formed integrally with the crash pad lower member 10, and similar to the duct groove 12 forming the first air conditioning duct 70, a groove resembling the duct groove 12 may be formed on the crash pad lower member 10. Alternatively, the second duct cover 40 may be formed in a shape that extends the groove recessed downwards, allowing the formation of the air conditioning duct without forming a separate groove on the crash pad lower member 10.

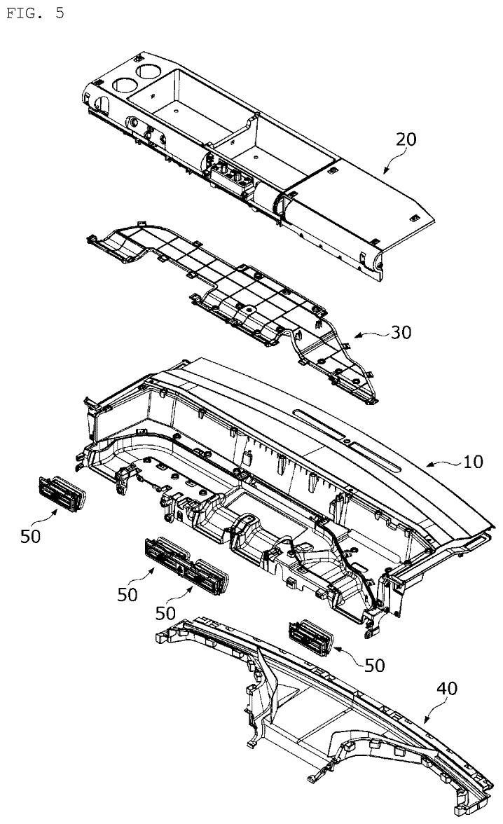

FIG. 5 is an exploded view of a cockpit module according to an embodiment of the present invention.

With reference to FIG. 5, in an embodiment of the present invention, the cockpit module 1 may include, from top to bottom based on FIG. 5, the crash pad upper portion 20, the first duct cover 30, the crash pad lower member 10, the second duct cover 40, and the air outlet 50.

Each component of the cockpit module 1 may be assembled vertically, and to achieve this, the molds for each component may be arranged and removed vertically during the manufacturing process. The crash pad lower member 10 is designed to have a predetermined distance step, and the duct groove 12 formed on the crash pad lower member 10 may be created by molds removed in a vertical direction from the upper side. Furthermore, the space formed on the top of the first air conditioning duct 70 may also be created with molds arranged and removed vertically to implement side walls formed with a deep depth and close to vertical angles, where the crash pad upper member 20 can be placed.

The shape of the trays 22 formed on the crash pad upper member 20 may also be obtained by placing and then removing molds during the formation of the crash pad upper member 20. The mold corresponding to the shape of the tray 22 may be arranged and removed vertically, ensuring the volume and deep depth of the tray 22.

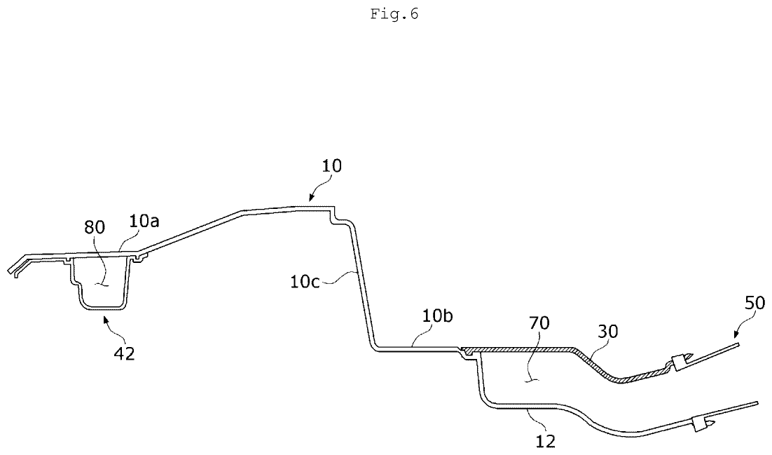

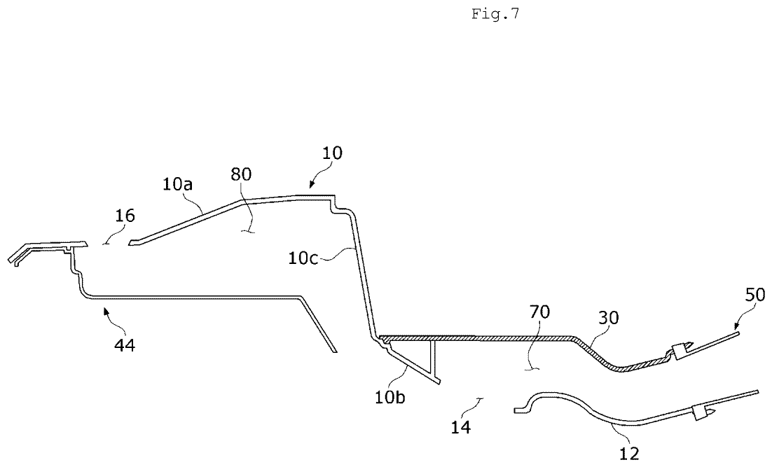

FIG. 6 is a side cross-sectional view of a crash pad lower member and a duct cover according to an embodiment of the present invention, and FIG. 7 is a center cross-sectional view of a crash pad lower member and a duct cover according to an embodiment of the present invention.

FIGS. 6 and 7 are diagrams illustrating the crash pad lower portion 10, the first duct cover 30, and the second duct cover 40 cut along the A-A line and B-B line shown in FIG. 1.

FIG. 6 shows the cross-section along line A-A of FIG. 1. With reference to FIG. 6, the crash pad lower member 10 is divided into two areas with a step, with the front corresponding to the left side and the rear to the right side based on FIG. 6. In the front, the second duct cover 40 is assembled to form the second air conditioning duct 80. In the rear, the duct groove 12 is formed by being recessed from the crash pad lower member 10, and the first duct cover 30 is assembled on top of the duct groove 12 to create the first air conditioning duct 70.

An air outlet 50 may be provided on the outlet side of the first air conditioning duct 70. The A-A line represents the position where the air outlet facing the side inside the vehicle is located, and the air outlet 50 may be combined with the crash pad lower member 10 and the first duct cover 30.

The first air conditioning duct 70 depicted in FIG. 6 may be a vent duct discharging air towards the side inside the cabin. The second air conditioning duct 80 may be a portion discharging air towards the front side of the vehicle through the side hose 44.

The crash pad lower member 10 may include the first area 10b and the second area 10a arranged with a step. The first area 10b and the second area 10a may be connected via a connecting portion 10c. That is, the crash pad lower member 10 may correspond to a combination of the first area 10b, the second area 10a, and the connecting portion 10c.

The first area 10b is placed at the rear of the cockpit module 1 and may be sunken with a predetermined step compared to the second area 10a. The duct groove 12 may be formed being recessed downwards in the first area 10b. The first duct cover 30 may be assembled in the first area 10b to create the first air conditioning duct 70.

The second area 10a is located at the front of the cockpit module 1. The underneath of the second area 10a may remain as empty space. Therefore, the second duct cover 40 may be placed in this space to form the second air conditioning duct 80. FIG. 6 represents the side of the cockpit module 1 where the side hose 44 branching air to the side is placed. Thus, the portion surrounded by the second duct cover 40 and the second area 10a forms the second air conditioning duct 80.

FIG. 7 shows the cross-section along line B-B of FIG. 1. With reference to FIG. 7, the crash pad lower member 10 may be divided into two areas arranged with a step, and a duct groove 12 may be formed by being recessed downwards. The B-B line corresponds to the center side of the cockpit module 1, and a hole 14 may be formed in the duct groove 12 to allow connection to the air conditioning unit. This portion is where air flows in from the air conditioning unit, so the width of the duct groove 12 may be formed wider compared to the side portion, and accordingly, the first duct cover 30 may also be formed wider.

Based on FIG. 7, the left side corresponds to the front of the vehicle, where the second air conditioning duct 80 may be formed. This portion may also be formed with one side open to connect to the air conditioning unit. A hole 16 may be formed in the crash pad lower member 10 to discharge air towards the windshield.

The second air conditioning duct 80 may be formed surrounded by the crash pad lower member 10 and the second duct cover 40. The crash pad lower member 10 may be divided into the second area 10a and the connecting portion 10c, and the space enclosed by the second area 10a, the connecting portion 10c, and the second duct cover 40 may correspond to the second air conditioning duct 80. Since the second air conditioning duct 80 also communicates with the air conditioning unit through the central portion 42, the width of the central portion 42 may be wider, while the side hose 44 on the side may be formed narrower.

The crash pad lower member 10 may include the first area 10b and the second area 10a arranged with a step, the first area 10b and the second area 10a being connected via the connecting portion 10c. That is, the crash pad lower member 10 may correspond to a combination of the first area 10b, the second area 10a, and the connecting portion 10c.

FIG. 7 represents the center of the cockpit module where holes that communicate with the air conditioning unit may be formed in the lower part of the second area 10a and the lower part of the first area 10b. Therefore, the first air conditioning duct 70 and the second air conditioning duct 80 in this portion may be formed with a wider width.

The second duct cover 40 is placed under the second area 10a, and it is important to form the cross-sectional area of the second air conditioning duct 80 wider to secure the amount of incoming air. This may be implemented by utilizing the empty space formed under the second area 10a, where the second air conditioning duct 80 may be formed enclosed by the second area 10a, the connecting portion 10c, and the second duct cover 40. This has the advantage of fully utilizing the space formed under the second area 10a. A hole 16 may be formed in the second area 10a to discharge air towards the windshield.

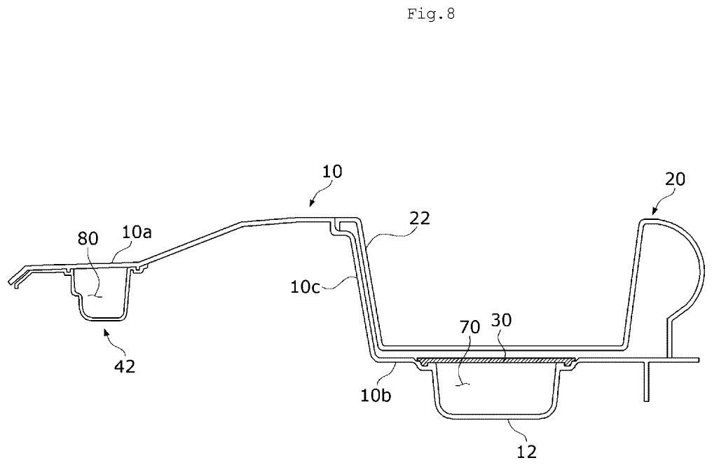

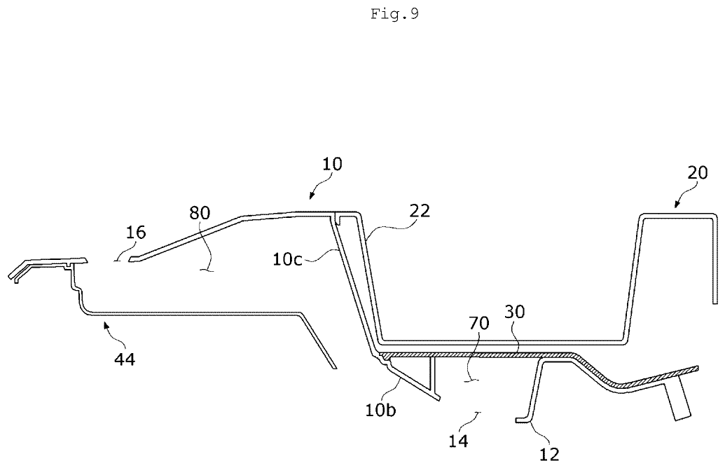

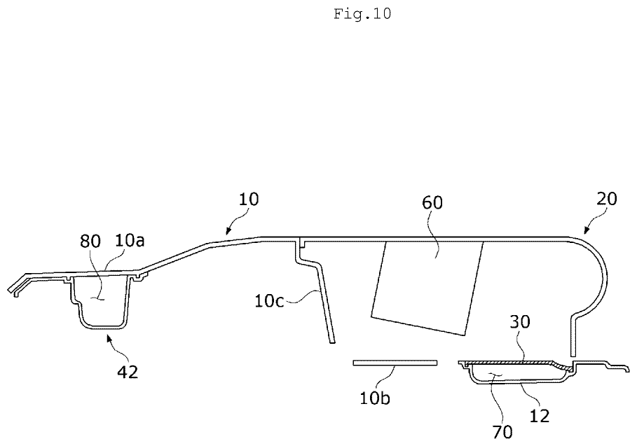

FIG. 8 is a cross-sectional view of the driver seat side of a cockpit module according to an embodiment of the present invention, FIG. 9 is a center cross-sectional view of the cockpit module according to an embodiment of the present invention, and FIG. 10 is a cross-sectional view of the passenger seat side of the cockpit module according to an embodiment of the present invention.

With reference to FIG. 1, trays 22 are formed on the driver seat and center sides of the cockpit module 1, while an airbag 60 is positioned on the passenger seat side, indicating that no tray 22 is formed on the passenger seat side. FIGS. 8 to 10 illustrate cross-sections of the areas where the air outlet 50 of the first air conditioning duct 70 is not formed.

With reference to FIG. 8, the crash pad upper member 20 may be assembled onto the crash pad lower member 10. FIG. 8 represents the driver seat side, where a tray 22 may be formed on the crash pad upper member 20. The tray 22 may be formed to occupy the space above the first air conditioning duct 70.

The tray 22 may be formed in a shape of being sunken downwards to have both side walls formed close to vertical, or even completely vertical. Deepening the tray 22 with the side walls formed at an angle close to vertical is capable of preventing items stored inside the tray 22 from falling out.

The entrance side of the tray 22 may be arranged on the same plane as the crash pad lower member 10. In detail, the crash pad lower member 10 includes the first area 10b and the second area 10a formed with a step, and the entrance of the tray 22 may be arranged on the same plane as the higher second area 10a. The entrance of the tray 22 may be provided on the upper side of the lower-placed first area 10b.

The first area 10b and the second area 10a are connected via a connecting portion 10c, and the depth of the tray 22 may correspond to the length of the connecting portion 10c, i.e., the step distance between the first area 10b and the second area 10a. The side walls of the tray 22 may be formed to be in contact with the connecting portion 10c or may be parallel to the connecting portion 10c. Therefore, the connecting portion 10c may also be arranged at a vertical or near-vertical angle.

FIG. 9 shows a cross-section corresponding to the center side. A tray 22 is also formed on the center side, and the tray 22 is shown in FIG. 9. The center side is formed with wider widths for the first air conditioning duct 70 and the second air conditioning duct 80, which are formed integrally with the crash pad lower member 10, occupying the empty space as much as possible.

The crash pad lower member 10, divided into the first area 10b and the second area 10a with a step, allows for the placement of the tray 22 on the top of the first area 10b, while duct groove 12 is formed by being recessed downwards in the first area 10b and covered by the first duct cover 30 to form the first air conditioning duct 70. The second air conditioning duct 80 is formed by placing the second duct cover 40 at the bottom of the second area 10a.

FIG. 10 shows a cross-section corresponding to the passenger seat side. This section corresponds to the cross-section along the C-C line in FIG. 1. An airbag module 60 may be installed on the passenger seat side, inside the cockpit module 1. The airbag 60 may be deployed by cutting the airbag door formed on the crash pad. Therefore, the airbag module 60 may be placed in the space where the tray 22 is formed on the driver seat and center sides. That is, a separate tray 22 may not be formed on the passenger side.

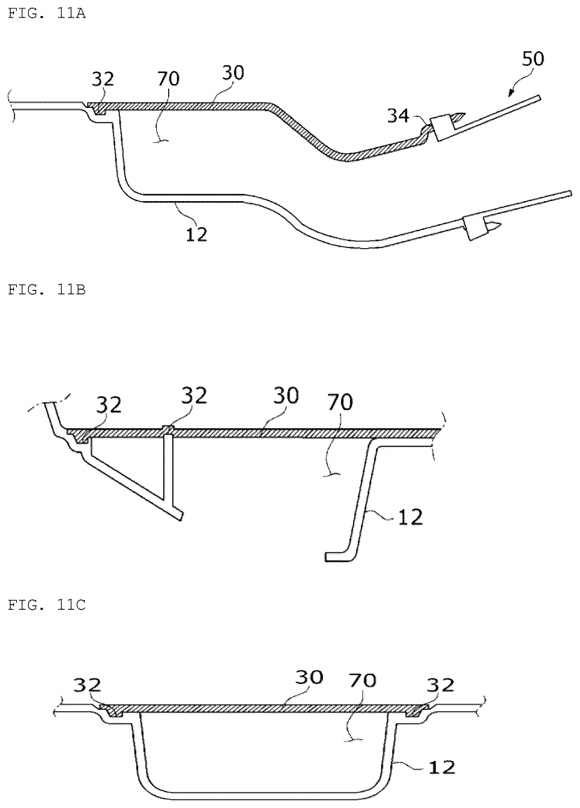

FIGS. 11A-C are diagrams illustrating the sealing structure of a duct cover according to an embodiment of the present invention.

The first duct cover 30 is assembled to the crash pad lower member 10 to form the first air conditioning duct 70. In this case, to prevent air from leaking between the crash pad lower member 10 and the first duct cover 30, a sealing structure may be applied to the assembly area of the first duct cover 30 and the crash pad lower member 10.

FIG. 11A illustrates the portion where the air outlet 50 is formed. A protrusion is formed on one end of the first duct cover 30 that projects in the direction where the crash pad lower member 10 is placed, and a corresponding recess may be formed on the crash pad lower member 10. The protrusion may be inserted into the corresponding recess, allowing the first duct cover 30 to be assembled onto the crash pad lower member 10. The protrusion may be formed to be projected out at least a portion thereof such that the projecting portion is joined to the crash pad lower member 10 in a line-touching structure. The crash pad lower member 10 and the first duct cover 30 are spaced apart with a narrow gap to prevent air leakage.

The other end of the first duct cover 30 may be joined to the air outlet 50. The other end of the first duct cover 30 may be assembled in a way that at least a portion thereof is inserted into the air outlet 50. The air outlet 50 may be inserted and fixed between the end of the crash pad lower member 10 and the end of the first duct cover 30.

FIGS. 11B-C are enlarged views of the joint between the first duct cover 30 and the crash pad lower member 10 in FIGS. 8 and 9. Since there is no air outlet 50 in this area, both ends of the first duct cover 30 are attached to the crash pad lower member 10. In the case, both the ends of the first duct cover 30 may be joined to the crash pad lower member 10 with a structure similar to that in FIG. 11A.

The first duct cover 30 may be provided with a plurality of coupling portions (e.g., sealing structures) formed at regular intervals along the perimeter thereof to facilitate the attachment of the first duct cover 30 to the crash pad lower member 10 and prevent air leakage. Similar to the first duct cover 30, the second duct cover 40 may also have a sealing structure for attachment to the crash pad lower member 10.

According to an embodiment of the present invention, a duct groove is formed on the underside of the crash pad with a duct cover provided to cover the groove, allowing the crash pad and air conditioning duct to be integrally formed, creating a tray space for increased storage capacity and preventing items stored inside from spilling out.

The advantageous effects of this invention are not limited to the aforesaid and will be more readily understood through the detailed description of the preferred embodiments of the invention.

While the foregoing description has focused on specific embodiments of the present invention, it should be understood that various modifications and changes can be made by those skilled in the art without departing from the spirit and scope of the invention as defined in the appended claims.

### DESCRIPTION OF REFERENCE NUMERALS

10: crash pad lower member
12: duct groove
20: crash pad upper member
22: tray
30: first duct cover
40: second duct cover
50: air outlet

What is claimed is:

1. A cockpit module comprising:
a crash pad lower member connected to an air conditioning unit;
a crash pad upper member coupled to the crash pad lower member; and
a first air conditioning duct formed integrally with the crash pad lower member,
wherein the crash pad lower member comprises:
a recessed duct groove and a first duct cover positioned on a top of the duct groove, the recessed duct groove and first duct cover defining the first air conditioning duct,
wherein the crash pad upper member includes a recessed tray and is coupled to the crash pad lower member such that the tray is positioned above the first duct cover and the first air conditioning duct.

2. The cockpit module of claim 1, wherein a coupling portion is formed at a predetermined interval along a perimeter of the duct groove, and a position of the first duct cover is fixed by the coupling portion.

3. The cockpit module of claim 2, wherein the first air conditioning duct comprises an air outlet formed at one end thereof, and the first duct cover is fixed by the air outlet at one end thereof.

4. The cockpit module of claim 3, wherein a second duct cover is coupled to the crash pad lower member and covers a lower portion of the crash pad lower member, and wherein the second duct cover and crash pad lower member define a second air conditioning duct.

5. The cockpit module of claim 4, wherein the first air conditioning duct is a vent duct, and the second air conditioning duct comprises a defrost duct and a side hose.

6. The cockpit module of claim 5, wherein the tray comprises a sidewall that is perpendicular to a bottom surface of the tray.

7. A cockpit module comprising:
a crash pad lower member comprising a second area configured to be placed in front of a vehicle, a first area positioned behind the second area, and a connecting portion connecting the first area and second area;
a first duct cover coupled to the crash pad lower member; and
a second duct cover coupled to the crash pad lower member,
wherein the first area and the second area are offset from one another by a step distance, and
wherein the second area is positioned above the first area, the second duct cover is positioned under the second area, and the second duct cover, second area and connecting portion define a second air conditioning duct, and
wherein the first area comprises a recessed duct groove, the first duct cover is positioned above the duct groove in the first area, and the duct groove and first duct cover define a first air conditioning duct.

8. The cockpit module of claim 7, wherein the first area accommodates a crash pad upper member on a top thereof, the crash pad upper member comprising a recessed tray having a depth corresponding to the step distance between the first area and the second area.

9. The cockpit module of claim 8, wherein the tray comprises a sidewall that is perpendicular to a bottom surface of the tray.

10. The cockpit module of claim 9, wherein the first air conditioning duct is a vent duct, and the second air conditioning duct comprises a defrost duct and a side hose.
